(19) United States
(12) Patent Application Publication
(10) Pub. No.: US 2004/0055469 A1
(43) Pub. Date: Mar. 25, 2004

(54) Vehicle cabin air purifier system

(76) Inventor: Kevin Kroculick, Milton, PA (US)

Correspondence Address: Kevin Kroculick, 115 RINGNECK DRIVE, HARRISBURG, PA, 17112, US

(21) Appl. No.: 10/252,762

(22) Filed: Sep. 23, 2002

(51) Int. Cl. B01D 53/02; B01D 46/00

(52) U.S. Cl. 96/134; 55/385.3; 55/486

(57) ABSTRACT

An air purification system comprised of a particulate filter element and activated carbon element that is secured to the vehicle's air inlet grille. Outside ambient air is therefore cleaned prior to it entering the vehicle's cabin. The air purification system is capable of removing allergens, dust, gasoline and diesel odors, particulates, and a wide range of other air pollutants. Purifying the ambient air as it comes into the vehicle's cabin promotes better health for the occupants and also keeps the interior of the vehicle clean. Changing the air purifying member is simple and relatively inexpensive.

### CROSS-REFERERENCE TO RELATED APPLICATIONS

Not Applicable

### STATEMENT REGARDING FEDERALLY SPONSERED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention relates to purifying the outside ambient air prior to it entering the cabin passenger compartment of a vehicle, such as an automobile, truck, or van. Removing dust, fumes, odors, allergens, and gases from the outside air before it enters the vehicle's ventilation system promotes a healthy environment for the vehicle's occupants, and also keeps the interior of the vehicle clean.

(2) Description of Related Art

A scientific report related to air quality entitled Evaluation of Subsurface Utilities and Indoor Air Environments As Migration Pathways and Points of Exposure In RBCA Site Assessment was issued in 1998. The study revealed that on road vehicles produced 46% of the benzene found in the ambient air in the United States. The study further determined that 19% of the benzene the average person is exposed to results from driving a car. The study also determined that the mean passenger compartment concentration while driving a car on the New Jersey Turnpike was 16.2 ug/m^{Λ}3. The USEPAs residential Risk Based Screening Level (RBSL) for benzene is 0.12 ug/m^{Λ}3. Therefore the average New Jersey driver may occasionally be exposed to benzene levels 135 times the RBSL. This information is very significant because benzene is a known carcinogen.

In 1999, the National Technical Information Service (NTIS) also issued the results of a study related to the indoor air quality of motor vehicles. This study corroborated the 1998 study by revealing that pollution levels inside or just outside vehicles were much higher than those measured at roadside stations or ambient air stations.

The results of these studies were of no surprise to anyone who has driven behind vehicles whose exhaust systems are not functioning properly, large diesel powered trucks or buses, or in more urban environments. It is therefore common knowledge that driving behind any inefficient or malfunctioning vehicle under any circumstances can result in exhaust fumes entering your vehicle, thus exposing the occupants directly to the harmful exhaust fumes.

Many proposals have been made in the past to supply the interior space of passenger vehicles with filtered air. However, problems arise in the realization of this concept. First, the filters are not effective on removing a wide range of pollutants. Second, the filter elements have caused too great a pressure drop in the vehicle's ventilation system. Third, the filter systems have been too complicated and expensive to install. Fourth, space is limited in most vehicles to support an elaborate filtration system. And fifth, most filter systems have the disadvantage of requiring original equipment manufacturer modification.

U.S. Pat. No. 3,941,034 provided for a filter to overly the vehicle's air inlet duct. A large rectangle sheet of laminated foil, vinyl and paper has a central opening over which is mounted a filter unit. The filter unit comprises two layers of non-woven paper heat sealed together to form a plurality of adjacent pockets, each of which contains pieces of activated charcoal. Filling pockets with activated charcoal is quite cumbersome for the average automobile owner. The foil, vinyl and paper made this invention unnecessarily difficult to manufacture.

U.S. Pat. No. 4,007,875 attempts to solve some of the problems associated with supplying filtered air with an air channel connected to a readily accessible space, such as under the hat storage area, where filter elements are housed in an air box. This system provides for an additional fan to offset the pressure drop caused by the filter, and a throttling mechanism for bypassing air when required. However, since the filter is a dry filter, the air requires pre-treatment, making this a relatively elaborate filtration system to install.

U.S. Pat. No. 4,319,519 also provides for an in-line filter element and a fan to offset pressure drops. However, this system does not provide for a carbon filter to reduce gaseous phase contaminants and odors.

U.S. Pat. No. 5,192,346, U.S. Pat. No. 5,368,620 and U.S. Pat. No. 6,129,140 provide for filters deep within the ducting system and require modification to the vehicles structure; hence are not really adaptable for retrofitting of an existing vehicle. These filtering systems are also relatively complex.

U.S. Pat. No. 5,350,444 provides for a filtration pillow, constructed of separate layers of filtration material to be placed in, and secured to the air filtration duct. Although this invention is intended to be a retrofit arrangement, the average vehicle owner is unable to dismantle the duct system for pillow installation and maintenance.

U.S. Pat. No. 6,080,059 provides for small filter units to be positioned at the air outlet inside the vehicle. However, people may perceive these filter attachments as aesthetically unpleasing, and may be apprehensive to adapt filter units to their vehicle's dashboard.

The above-cited inventions are commendable attempts to reduce the air pollution levels inside passenger vehicles. However, they have not received widespread favor because of the additional costs associated with the installation and maintenance of these systems, and because these inventions are unnecessarily complex.

It should also be noted that many vehicles allow the operator to select “recycle” mode on the air control panel. Selecting the recycle mode causes the diverter door located in the air intake section of the heater/cooling system to open. Therefore, the primary source of air that is fed to the air heater core/evaporator plenum comes from inside the vehicle. However, the recycle mode still does allow some outside air, usually 40%, to enter the heater/cooling core. The air recycle mode also has a tendency to cause the windows to fog.

Therefore, whatever the precise merits, features, and advantages of the above-cited systems, none of them achieves or fulfills the purposes of the present invention.

It is therefore an object of the present invention to provide a design of a simple air filter member which can overlay the intake duct of a passenger motor vehicle as to extract common pollutants from the ambient air as they are drawn into the vehicle's ventilation system.

### BRIEF SUMMARY OF THE INVENTION

The primary objective of the present invention is to provide a filter member which is adapted to be mounted in overlaying relationship to the air intake of a passenger automobile, truck, or van which provides means for filtering exhaust fumes, odors, pollen, smoke, allergens, particulate matter and other pollutants from the ambient air before it enters the cabin compartment. The filter member is simply cut to roughly the same shape as the air inlet grill, and then secured thereto with duct tape or other securing means.

Another object of the invention is to provide such a device which is simple and economical to manufacture, so that it is capable of being sold at a relatively low price for widespread use.

Another object of the present invention is to provide such a device so the average vehicle owner is capable of performing the installation.

It is therefore another object of the present invention to promote a cleaner, healthier driving environment, which provides for a feeling of safety when driving.

It is another object of the present invention to help relieve fatigue and promote alertness while driving.

It is still another object of the present invention to help keep the interior of the vehicle clean.

It is still another objective of the present invention to provide an air-filtering device that the average person understands how it functions.

Still further objects and advantages will become apparent from a consideration of the ensuing description and drawings.

While there is shown in the accompanying drawings a prefer embodiment of the invention, it should be understood that the same is susceptible to modification and change without departing from the spirit of the invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the drawings wherein:

FIG. 1 is a front isometric view of a typical automobile with the hood open, depicting the air ventilation system.

FIG. 2A is a top isometric view of the filter member.

FIG. 2B is a bottom isometric view of the filter member.

FIG. 2C is a front view of the filter member.

FIG. 3 is a front isometric view of a typical automobile without the filter member attached to the vehicle.

FIG. 4 is a front isometric view of a typical automobile with the filter member attached to the vehicle.

FIG. 5 is a side perspective view of a typical automobile that has the hood substantially covering the air inlet grille.

### DETAILED DESCIPRTION OF THE INVENTION

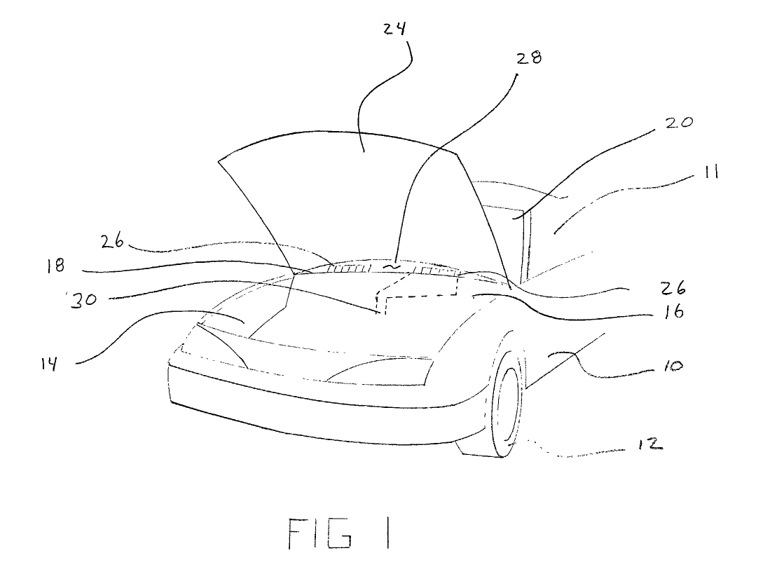

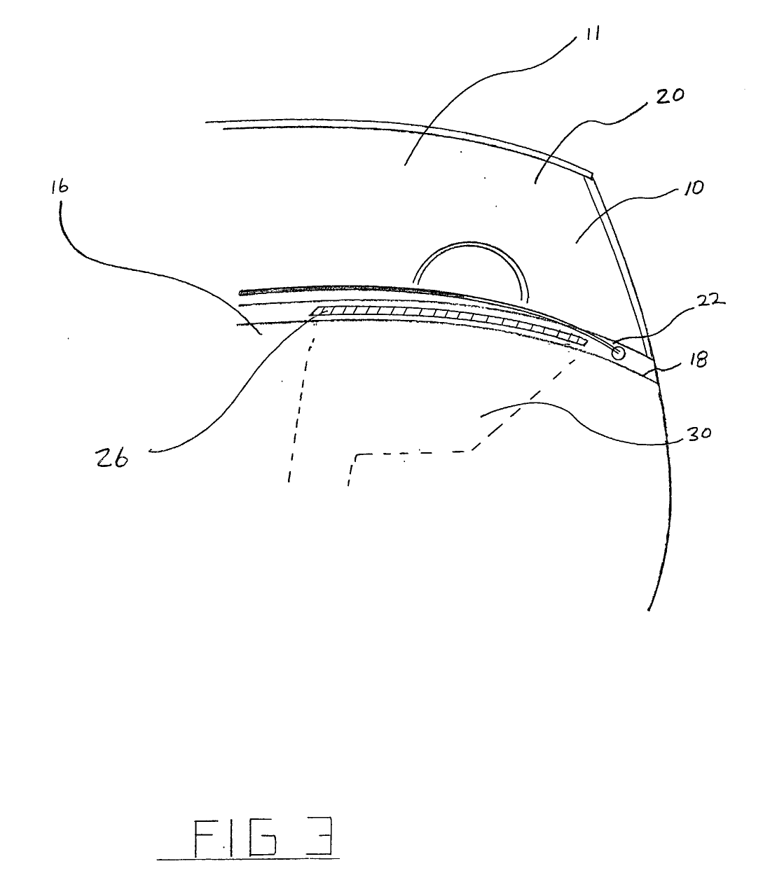

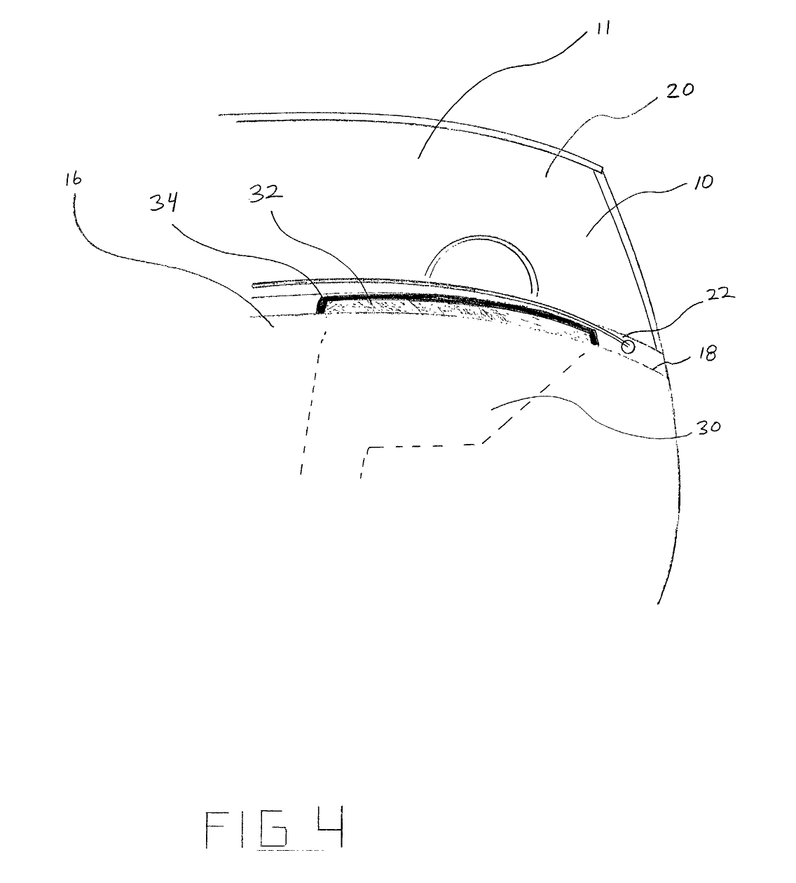

A typical passenger vehicle (10) as shown in FIG. 1 and FIG. 3 includes a passenger compartment (11), wheel (12) and engine compartment (14) which is separated from the passenger compartment (11) by firewall (16). Connected to firewall (16) is hood gasket (18). Windshield (20) is provided at the front of passenger compartment (11). At the front of the windshield (20) is windshield wiper (22). At the front of windshield wiper (22) and positioned above engine compartment (14) is hood (24).

Underlying hood (24) is air inlet grille (26). Air is drawn into the air inlet grille (26) which is channeled in ventilation air duct (30) which is located behind the firewall (16). The air ultimately outlets into passenger compartment (11). In many vehicles, space (28) separates two air inlet grilles (26). However, in some vehicles, one air inlet grille (26) is false, meaning it has no function other than to provide a symmetric appearance.

The vehicle of the present invention is modified by the addition of filter member (32) which is cut complementary to, but slightly larger than the shape of inlet grille (26). Filter member (32) is disposed directly over the inlet grille (26) and is secured preferably with duct tape (34) or other means of adjoinment to the outer three edges of inlet grille (26), while the fourth edge is typically tucked under hood gasket (18). After the shape of the filter member is established during the first installation, it can be used at a pattern for cutting all subsequent filter members.

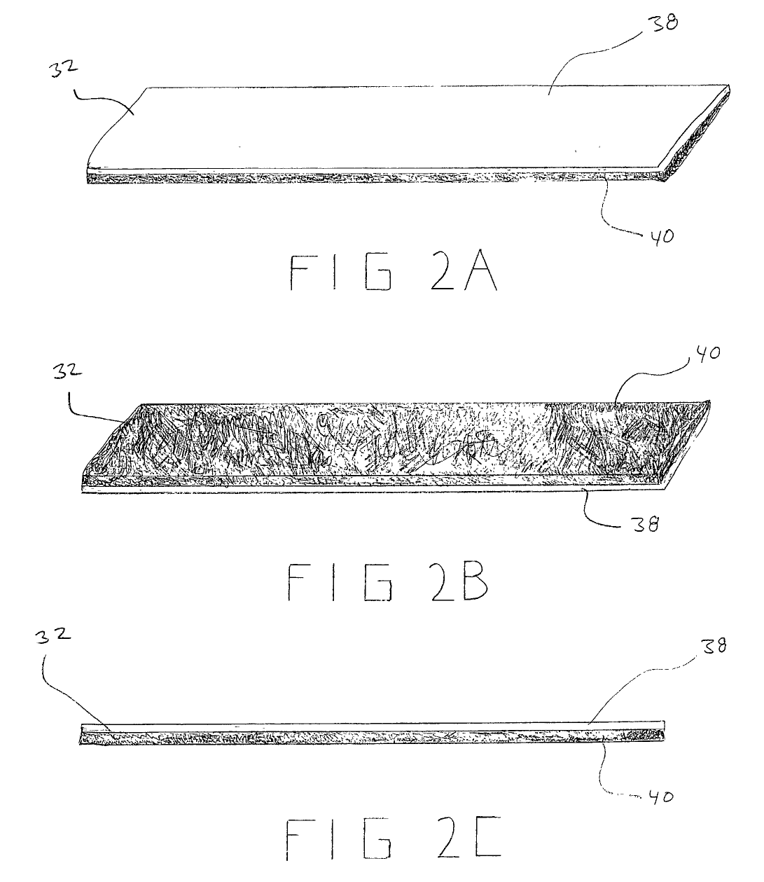

Filter member (32) is shown is FIGS. 2A, 2B, and 2C. Filter member (32) is preferably comprised of at least two air-purifying elements in tandem to help purify the outside ambient air prior to it entering the vehicle's air ventilation duct (30). The outside ambient air first passes through particulate filter element (38). The air then passes through activated carbon filter element (40). Particulate filter (38) removes a large percentage of particulates present in the ambient air, such as dust, pollen, and bacteria. Activated carbon element (40) removes a large percentage of the gaseous phase contaminants such as volatile organic contaminants and odors, and also serves to remove a portion of the remaining particulate matter. The particulate filter element and activated carbon filter element is generally connected by means of adhesive or other bonding means.

The present invention takes advantages of proven air cleansing principles and technologies; particulate filtration and carbon adsorption. These technologies simultaneously provide for maximum free air passage and increased contaminant removal efficiencies, while providing for long service intervals.

Filter member (32) is typically purchased in larger sheets. The vehicle's operator or person performing the installation simply cuts filter member (32) to the approximate shape of the vehicle's air inlet grille (26). In alternative embodiments the filter member (32) can be packaged and sold in sizes for specific vehicle models. Filter member (32) is secured in place with duct tape (42) or other means of adjoinment. Filter member (32) should be replaced approximately every 3,000-road miles, or as conditions warrant.

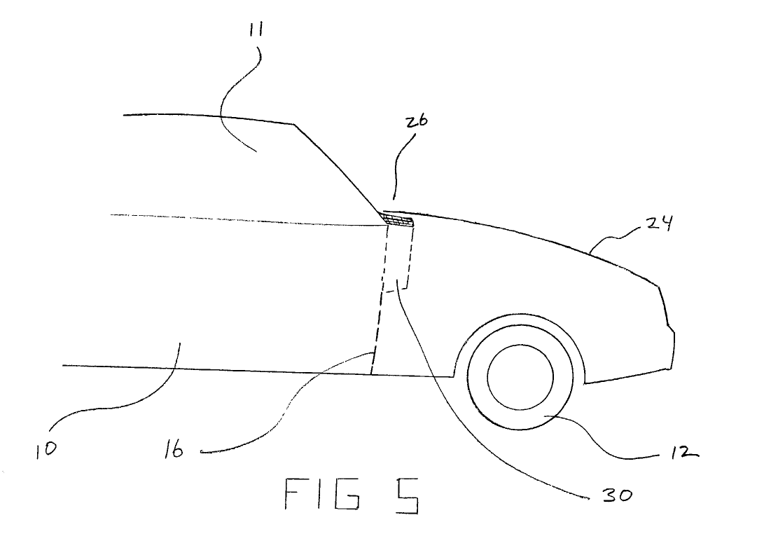

Examples of particulate filters that can be utilized as particulate filter element (38) are sold by the 3M Company and Air Sponge Filter Company, under the trademark names Filtrete and BioSponge, respectively. Examples of activated carbon filters that can be utilized as activated carbon filter element (40) include those sold by Bonaire, Hamilton Beach, or Honeywell. These activated carbon filters are typically utilized with these company's portable home air filter units. The Air Sponge Company also provides activated carbon filters that are utilized in the custom frame housings designed for their furnace filters. Filter member (32) is intended to be utilized with vehicles that do not have the air inlet grille (26) directly exposed to the atmospheric elements. Filter member (32) is intended for vehicles that have the air inlet grille totally, or substantially covered by the hood, as shown in FIG. 5.

I claim:

1. A cabin air purifying system for vehicles containing a passenger compartment comprising:
a) A contiguous member consisting of a particulate filter element and activated carbon filter element removablely secured to or near the perimeter of the vehicle's air inlet grille;
b) A means to secure filter member, preferably with duct tape, to or near the perimeter of the vehicle's air inlet grille; and
c) An air purification system removably secured to said perimeter of air inlet grille whereby said particulate filter element removes at least a portion of particles present in the ambient air, and whereby said carbon filter element removes at least a portion of gaseous phase contaminants from the ambient air,
Whereby said Vehicle Cabin Air Purification System prevents the vehicle's occupants from being directly exposed to harmful elevated highway related pollution, noxious odors, and allergens.

2. A cabin air purification system according to claim 1 wherein said particulate filter element and activated carbon filter element are secured together using adhesive or other bonding means.

3. A cabin air purification system according to claim wherein said particulate filter element and activated carbon filter element do not significantly impede airflow through said air inlet grille.

4. A cabin air purification system according to claim to 1 wherein said filter is purchased in a sheet by the consumer.

5. A cabin air purification system according to claim 1 wherein said filter member is cut by the consumer to the approximate shape of the vehicle's air inlet grille.

6. A cabin air purification system according to claim 1 wherein said filter member is preferably secured to the perimeter of the inlet grille with adhesive tape.

7. A cabin air purification system according to claim 1 further which is preferably to be used in vehicles whereby the air inlet grill is covered substantially by the vehicle's hood, limiting the filter members exposure to precipitation and air turbulence.

8. A method for purifying the cabin air of a passenger vehicle comprising the steps of:
a) Combining at least one particulate filter element and at least one active carbon filter element to form one contiguous filter member.
b) Providing that filter member is sold in relatively large sheets, approximately 3 feet wide by 10 feet long.
c) Providing instructions with filter member indicating that filter member should be cut with scissors to a size complimentary to, but slightly larger than, the vehicle's air inlet grille(s).
d) Providing instructions with filter member recommending that filter member should only be utilized with vehicles that have the hood totally, or substantially, covering the vehicle's air inlet grille(s).
e) Providing instructions with filter member indicating that filter member should be placed in an overlying relationship to the air inlet grill(s).
f) Providing instructions with filter member indicating that filter members leading edge should be tucked under the vehicle's hood gasket if feasible.
g) Providing adhesive tape or other securing means so that filter member can be secured to the perimeter of the air inlet grille(s).
h) Providing instructions with filter member indicating that filter member should be replaced approximately every 3,000 miles, or as conditions warrant.
i) Providing instructions with filter member indicating that each used filter member can be utilized as a pattern to cut subsequent filter members.
Whereby polluted ambient air is partially remediated prior to it entering the vehicle's air ventilation system.
